(19) United States
(12) Patent Application Publication
(10) Pub. No.: US 2024/0399815 A1
(43) Pub. Date: Dec. 5, 2024

(54) MOTOR VEHICLE AIR CONDITIONING SYSTEM

(71) Applicant: Hanon Systems, Daejeon (KR)

(72) Inventors: Nitin Ramesh Chincholkar, Kerpen (DE); Evzi Duka, Köln (DE); Christoph Capellmann, Würselen (DE); Peter Klotten, Köln (DE); Martin Paul Nowak, Rösrath (DE)

(21) Appl. No.: 18/625,288

(22) Filed: Apr. 3, 2024

(30) Foreign Application Priority Data
May 31, 2023 (DE) 10 2023 114 204.6

(51) Int. Cl. B60H 1/00

(52) U.S. Cl. CPC B60H 1/00064; B60H 2001/00092

(57) ABSTRACT

A motor vehicle air conditioning system includes an internal air guiding device with a plurality of warm air ducts at the end of a warm air path and at an entrance to a mixing space, each warm air duct being designed to guide warm air to at least one air outlet, that is to say, in a direction of at least one defrost outlet, at least one ventilation outlet, or at least one footwell outlet. The warm air ducts are each designed to be open on one side along a predominant part of the course of the warm air ducts in a longitudinal direction of the warm air ducts.

### CROSS-REFERENCE TO RELATED APPLICATION

The present application claims the benefit of and priority to German Patent Application No. 10 2023 114 204.6, filed May 31, 2023, the entire contents of which are incorporated herein for all purposes by reference.

### FIELD

The invention relates to a motor vehicle air conditioning system with an internal air guiding device.

### BACKGROUND

Internal air guiding devices are used to guide and mix air flows in a motor vehicle air conditioning system to achieve defined air quantities and air temperatures in the outlets in each case, in particular in defrost outlets, ventilation or dashboard outlets or footwell outlets. In motor vehicle air conditioning systems there are two main air flows, a hot main air flow from a heating heat exchanger and a cold main air flow from an evaporator. The internal air guiding devices usually form a closed construction with ducts closed on the side walls, for example with tubular ducts, some of which originating from a common connecting wall, as a result of which the air guiding devices usually have a complex design, the production of which is complex and, therefore, also requires complex, expensive manufacturing tools. This leads to significant additional costs. In addition, the air flows through pipes closed on the side walls, which blocks a large part of the flow cross section, especially in footwell mode. This leads to a greater restriction of airflow to the footwell outlet, more pressure loss and a higher fan speed. This pressure loss has a negative impact on the vehicle characteristics in terms of audible or noticeable vibrations, usually referred to as “noise, vibration, harshness” (NVH). For this reason, the design is susceptible to the creation of larger sources of noise.

### SUMMARY

It is the object of the invention to develop a simplified design for the internal air guiding device, to reduce the complexity and costs of the manufacturing tools required to produce it, and to lower the noise caused by the internal air guiding device when operating a motor vehicle air conditioning system.

This task is achieved by a motor vehicle air conditioning system with the features as shown and described herein.

A motor vehicle air conditioning system according to the invention comprises
a fan to generate an air flow,
a housing for guiding the air flow, in which at least one defrost outlet, at least one ventilation outlet and at least one footwell outlet are formed,
an evaporator arranged in the housing and through which the air flow can flow, and, downstream of the evaporator, a heat exchanger arranged in the housing and through which the air flow can flow, wherein, starting from a cold air space located downstream of the evaporator and upstream of the heat exchanger, a cold air path bypassing the heat exchanger and a warm air path running through the heat exchanger lead downstream into a mixing space, which is connected to the at least one defrost outlet, the at least one ventilation outlet or dashboard outlet, and the at least one footwell outlet, and
an internal air guiding device with a plurality of warm air ducts at the end of the warm air path and at the entrance to the mixing space, each warm air duct being designed to guide warm air to at least one of said air outlets mentioned, that is to say, in the direction of at least one defrost outlet, at least one ventilation outlet or at least one footwell outlet.

According to the invention, the warm air ducts are each open on one side along a predominant part of the course of the warm air duct in a longitudinal direction of the warm air duct and are therefore trough-shaped. With respect to the warm air ducts, the term longitudinal direction is to be understood as the direction of the longest extension of the respective warm air duct.

The invention is used to guide and mix air flows of the motor vehicle air conditioning system in order to achieve defined air quantities and air temperatures in the outlets. Because the air is not guided through closed pipes, the pressure loss is reduced. This design is associated lower local accelerations coupled with better aero-acoustic performance compared to closed pipe designs. The open design of the warm air ducts of the air guiding device also enables to produce this part from plastic using simple manufacturing tools without the need for additional slides.

According to an advantageous embodiment of the invention, the warm air ducts are arranged separately from one another, such that several of the warm air ducts do not originate from a common connection. The open warm air ducts are preferably arranged parallel to one another.

At least one of the open warm air ducts preferably has a U-shaped cross section. This means that the warm air ducts each have two side walls as U-legs and a bottom as a U-base, which extend in the longitudinal direction of the respective warm air duct.

According to an embodiment of the invention, at least one warm air duct, which is designed and oriented to guide a warm air flow to the at least one defrost outlet, has an end region in which the warm air duct is closed by a wall, whereby the open region of the warm air duct ends, the wall being adjacent to an outlet opening of the warm air duct for guiding warm air to the defrost outlet.

According to a further embodiment of the invention, at least one warm air duct, which is designed and oriented to guide warm air to the at least one ventilation outlet of the dashboard, has an end region continually enlarging up to an end face of the warm air duct, wherein the end face may be either completely or only partially closed. In this way, the end face of the warm air duct may be provided with an air outlet opening. Also, at least one warm air duct, which is designed to guide warm air to the at least one footwell outlet, preferably has an end region continually enlarging up to an end face with the end face being completely or partially closed. The end regions of the various warm air ducts can be enlarged by continuously increasing the heights of opposing side walls and thus the lengths of U-legs of a U-shaped cross section of the respective warm air duct in the end region up to the respective end face.

According to one embodiment of the invention, a baffle for introducing warm air into the respective warm air duct is arranged on each of the open sides of the warm air ducts. Alternatively, a common baffle for introducing warm air into the warm air ducts can be arranged over the entire width of the air guiding device and the open sides of the warm air ducts.

### BRIEF DESCRIPTION OF THE DRAWINGS

Further details, features and advantages of embodiments of the invention result from the following description of exemplary embodiments with reference to the associated drawings. In the figures:

FIG. 1A: shows an air guiding device with warm air ducts with a view on outlet openings of the warm air ducts, prior art,

FIG. 1B: shows the air guiding device with the warm air ducts in a further perspective view, prior art,

FIG. 2A: shows a partial cross section of a motor vehicle air conditioning system with a built-in air guiding device, prior art,

FIG. 2B: shows a front view of the motor vehicle air conditioning system, prior art,

FIG. 2C: shows another partial cross section of the motor vehicle air conditioning system, prior art,

FIG. 3A: shows a further air guiding device with warm air ducts in a perspective view, prior art,

FIG. 3B: shows the further air guidance device with warm air guidance ducts in a perspective view, prior art,

FIG. 4A: shows an air guiding device with an open design according to an embodiment of the invention in a perspective view looking at the rear,

FIG. 4B: shows the air guiding device with an open design in a perspective view looking at the front,

FIG. 5A: shows an air guiding device with an open design according to a further embodiment of the invention in a perspective representation looking at the rear,

FIG. 5B: shows the further air guiding device with an open design in a perspective representation looking at the front,

FIG. 6A: shows a part of an air guiding device according to the prior art in a perspective representation,

FIG. 6B: shows a part of an air guiding device with an open design in a perspective representation,

FIG. 7A: shows a schematic perspective representation of the arrangement of the air guiding device within the housing of a motor vehicle air conditioning system looking at an open rear of warm air ducts, and

FIG. 7B: shows a schematic perspective representation of the arrangement of the air guiding device within the housing of the motor vehicle air conditioning system looking from the front to the end faces of the warm air ducts

### DETAILED DESCRIPTION

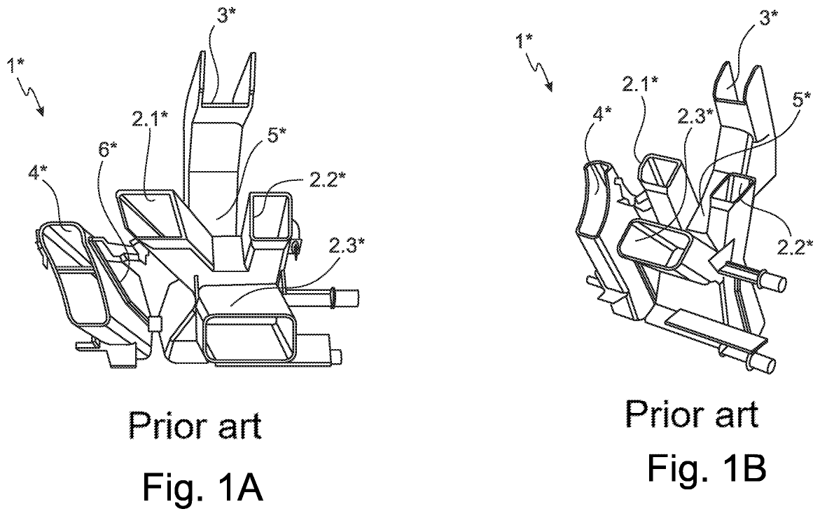

Internal air guiding devices, such as the air guiding device 1* shown in the figures FIG. 1A and FIG. 1B are used to guide and mix air flows in a motor vehicle air conditioning system to achieve defined air quantities and air temperatures in each case in air outlets of the motor vehicle air conditioning system, for example in at least one defrost outlet, at least one ventilation outlet or at least one footwell outlet. According to the prior art shown in the figures FIG. 1A and FIG. 1B, the internal air guiding device 1* forms a substantially closed construction with warm air ducts 2.1*, 2.2*, 2.3*, 3*, 4* closed predominantly on the side walls. In the example shown, the warm air ducts 2.1*, 2.2*, 2.3*, 3*, 4* are tubular ducts that have a square-shaped cross section. As shown in the figures FIG. 1A and FIG. 1B, the air guiding device 1* has two warm air ducts 2.1*, 2.2* for the ventilation outlets of the front zones, that is to say a warm air duct 2.2* for a central ventilation outlet of the dashboard and a warm air duct 2.1* for a side ventilation outlet of the dashboard, which originate from a common base body 5* connecting them to one another. In addition, in the case of a multi-zone air conditioning system, an additional warm air duct 2.3* is necessarily formed for the back zones of the passenger compartment, which also originates from the common base body 5*. Another, relatively long warm air duct 3*, which originates from the common base body 5* and, relative to the direction of the vehicle, is positioned in front of the warm air ducts 2.1*, 2.2* for the ventilation outlets of the front zones, is oriented in the direction of a defrost outlet and is used to supply said defrost outlet with warm air to defrost the windshield. In addition, the figures FIG. 1A and FIG. 1B show a laterally closed warm air duct 4* for supplying a footwell outlet with warm air. Because different warm air ducts 2.1*, 2.2*, 2.3*, 3* originate from a common connection, the internal air guiding device 1* has a complex, closed design, the production of which is complex and, therefore, also requires complex, expensive manufacturing tools. In addition, the closed shape of the warm air ducts 2.1*, 2.2*, 2.3*, 3*, 4* is usually only achieved by assembling several parts, for example by a tongue and groove connection 6*, which is shown in FIG. 1A at the warm air duct 4* which is designed and oriented for supplying the footwell outlet with warm air. Such tongue and groove connections increase both the complexity of the manufacturing tool and the effort involved in assembling the internal air guiding device.

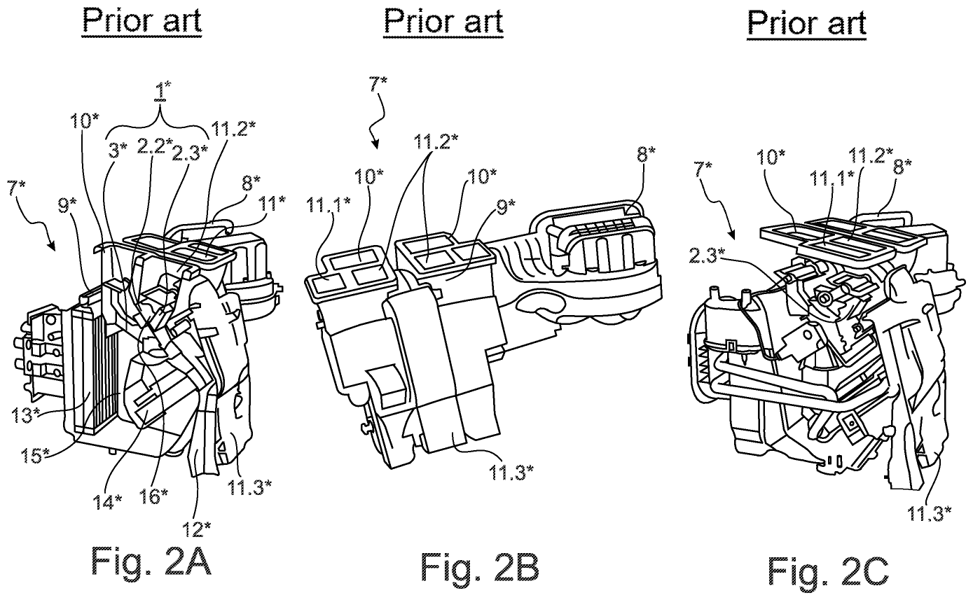

The figures FIG. 2A, FIG. 2B and FIG. 2C show various representations of a motor vehicle air conditioning system 7*, in which the air guiding device 1* shown in the figures FIG. 1A and FIG. 1B from the prior art is installed as an internal air guiding device 1*. This motor vehicle air conditioning system 7* comprises a fan 8* for generating an air flow and a housing 9* for guiding the air flow, in which defrost outlets 10*, ventilation outlets 11* and footwell outlets 12* are formed. FIG. 2A shows a partial cross section that allows a view into the interior of the housing 9* of the motor vehicle air conditioning system 7*, the housing 9* being arranged next to the fan 8*. An evaporator 13* through which the air flow can flow and, a heat exchanger 14* through which the air flow can flow downstream of the evaporator 13* are arranged in the housing 9*. Starting from a cold air space 15* located downstream of the evaporator 13* and upstream of the heat exchanger 14*, a cold air path bypassing the heat exchanger 14* and a warm air path running through the heat exchanger 14* lead downstream into a mixing space 16*, which is connected to the defrost outlets 10*, the ventilation outlets 11* and the footwell outlets 12*. In addition, the motor vehicle air conditioning system 7* comprises the internal air guiding device 1* described above with a plurality of warm air ducts 2.1*, 2.2*, 2.3*, 3*, 4* at the end of the warm air path and at the entrance to the mixing space 16*, each warm air duct 2.1*, 2.2*, 2.3*, 3*, 4* being designed or oriented to guide warm air to at least one of the air outlets 10*, 11*, 12* mentioned. The motor vehicle air conditioning system 7* shown in the figures FIG. 2A, FIG. 2B and FIG. 2C is a multi-zone air conditioning system with ventilation outlets 11.1* for the front seats and with at least one ventilation outlet 11.3* for the back seats of the passenger compartment. Here, as can be seen in the figures FIG. 2A and FIG. 2C, the air guiding device 1* has the warm air duct 2.3*, which is provided for supplying the ventilation outlet 11.3* of the back zones of the passenger compartment with warm air, in addition to the partially visible warm air ducts 2.2* which are designed and oriented for supplying the ventilation outlets 11.1*, 11.2* on the driver side and the passenger side, respectively, with warm air. FIG. 2B shows a front view of the motor vehicle air conditioning system 7* looking at the ventilation outlet 11.3* for the back seats of the passenger compartment as well as the footwell outlets 12* and the fan 8*, with the front ventilation outlets 11.1*, 11.2* and the defrost outlets 10* on the driver side and passenger side being also visible. FIG. 2C is a schematic representation of the motor vehicle air conditioning system 7* with the air guiding device 1* placed therein, the walls of the air outlets being omitted for clarity.

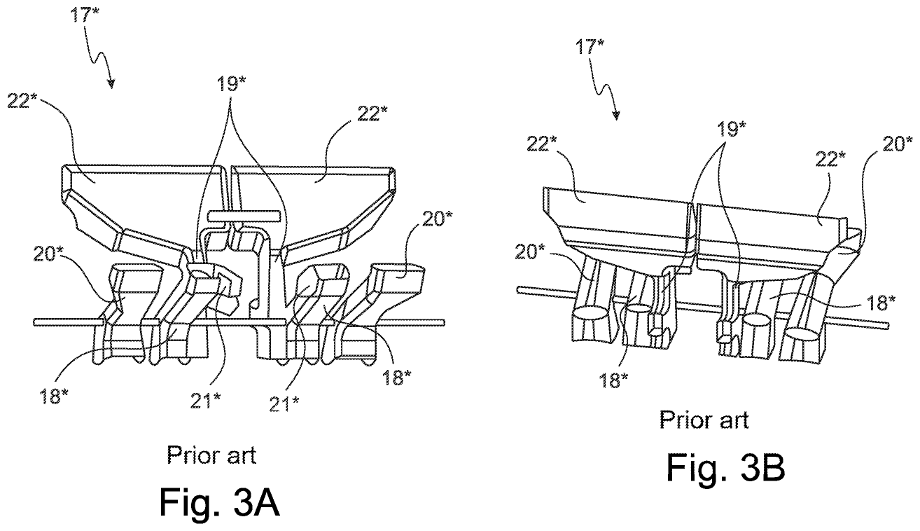

The figures FIG. 3A and FIG. 3B show a further air guiding device 17* with warm air ducts 18*, 19*, 20* from the prior art in a perspective representation, with FIG. 3A showing a rear view and FIG. 3B showing a front view, each relative to the direction of the vehicle. In this air guiding device, the laterally closed warm air ducts 18*, 19*, 20* are arranged separately and substantially parallel to one another. Here, two warm air ducts 18* are provided for supplying the ventilation outlets of the dashboard, with a bypass 21* being formed in each end region of these warm air ducts 18* and which is provided to guide warm air to a ventilation outlet for the back zones of the passenger compartment. Two further warm air ducts 19* are designed and oriented to supply the defrost outlets with warm air, these warm air ducts 19* having a complex design with cross-sectional expansions in the end regions 22* facing the defrost outlets. The outermost warm air ducts 20* of the air guiding device 17* on both sides, are provided to supply the footwell outlets with warm air. Although the different warm air ducts 18*, 19*, 20* are arranged separately from one another, the sometimes very complex design of the predominantly laterally closed warm air ducts 18*, 19*, 20*, in particular the closed design of the warm air ducts 18* with bypasses 21* or the warm air ducts 19* with end regions 22* that expand the flow cross section, requires complex manufacturing tools, which makes production more difficult and increases costs. In addition, the air flows through pipes closed on the side walls, which blocks a large part of the flow cross section, especially in the heating modes and in the footwell mode. This leads to a greater restriction of airflow to the footwell outlet, more pressure loss and a higher fan speed. This pressure loss has a negative impact on the vehicle characteristics in terms of audible or noticeable vibrations, usually referred to as “noise, vibration, harshness” (NVH). For this reason, this design is also susceptible to the creation of larger sources of noise.

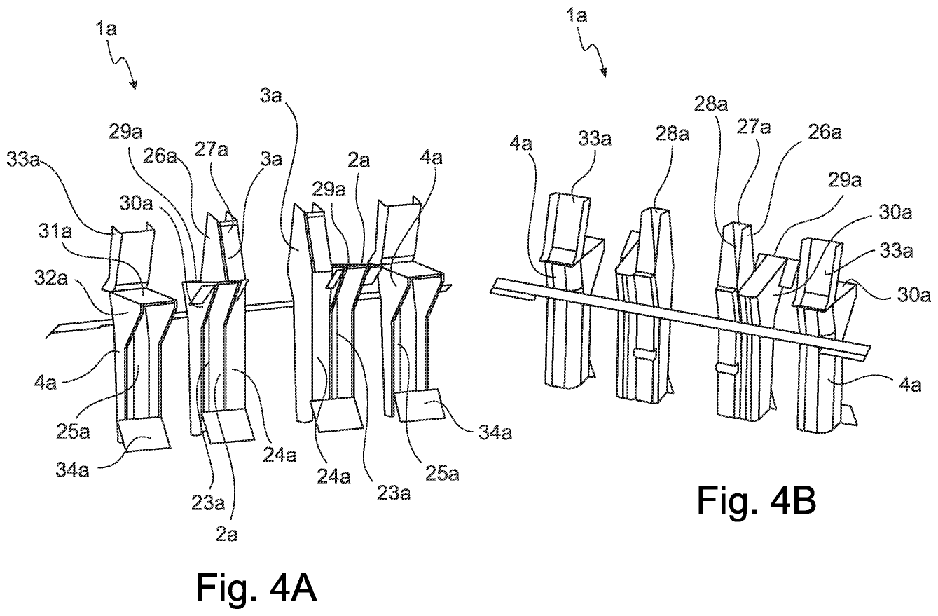

The figures FIG. 4A and FIG. 4B show an air guiding device 1a with warm air ducts 2a, 3a, 4a, which have an open design, in a perspective representation in each case. Here, FIG. 4A shows a perspective representation of the air guiding device 1a looking towards the rear, while the perspective representation in FIG. 4B offers a view towards the front. Here, the distinction between front and rear or “front” and “back” is relative to the vehicle direction of a motor vehicle in which a motor vehicle air conditioning system provided with the air guiding device 1a is installed. Several warm air ducts are arranged substantially parallel and separated from one another in the air guiding device 1a, and are equipped with relatively simple design features. All warm air ducts 2a, 3a, 4a have in common that they each have an at least predominantly open rear 23a, 24a, 25a and, as a result, have a U-shaped cross section with two opposite side walls as U-legs in each case, and a bottom that forms the closed part on the front of the respective warm air duct 2a, 3a, 4a as a U-base.

In the arrangement of the warm air ducts 2a, 3a, 4a of the air guiding device 1a, the innermost warm air ducts 3a are provided to supply at least one defrost outlet with warm air. These warm air ducts 3a each have an enlarging end region 26a, in which the warm air duct 3a is closed on the rear by a wall 27a that is inclined slightly forward, whereby the open region of the rear 24a ends. Due to the inclination of the wall 27a, air that flows through the respective warm air duct 3a is directed in the direction of an outlet opening 28a of the warm air duct 3a, said outlet opening 28a being formed by an unclosed end face adjacent to the wall 27a and an unclosed front of the end region 26a opposite the inclined wall 27a, as can be seen from the front view of the air guiding device 1a in FIG. 4B.

According to the air guiding device 1a shown in the figures FIG. 4A and FIG. 4B, the warm air ducts 2a, which are placed second or in the middle on both sides, are provided for supplying the ventilation outlets and dashboard outlets, respectively, with warm air. These warm air ducts 2a each have an end region 30a continually enlarging up to an end face 29a, the enlargement being effected in such a way that the heights of the opposite side walls and thus the lengths of the U-legs of the U-shaped cross section of the respective warm air duct 2a in the end region 30a increases continuously up to the end face 29a. The end faces 29a are each designed to be closed in the embodiment shown in the figures FIG. 4A and FIG. 4B, these warm air ducts 2a having an open rear 24a over their entire length up to the end face 29a in each case.

The warm air ducts 4a, each positioned on the outside, are provided to supply the footwell outlets with warm air and are each designed to be open on their rear 25a up to a closed end face 31a. These warm air ducts 4a also each have an end region 32a continually enlarging up to their end face 31a, the enlargement being effected in such a way that the heights of the opposite side walls and thus the lengths of the U-legs of the U-shaped cross section of the warm air duct 4a in the end region 32a increase continuously up to the end face 31a. A shielded auxiliary duct 33a originates from the end faces 31a of the warm air ducts 4a for the footwell outlets in order to guide warm air to the defrost outlet. The auxiliary ducts 33a are shielded to prevent the warm air from being blocked by cold air.

As can be seen in particular from FIG. 4A, a baffle 34a is arranged on each of the warm air ducts 2a, 3a, 4a in a respective air inlet region on the rear 23a, 24a, 25a of the warm air duct 2a, 3a, 4a.

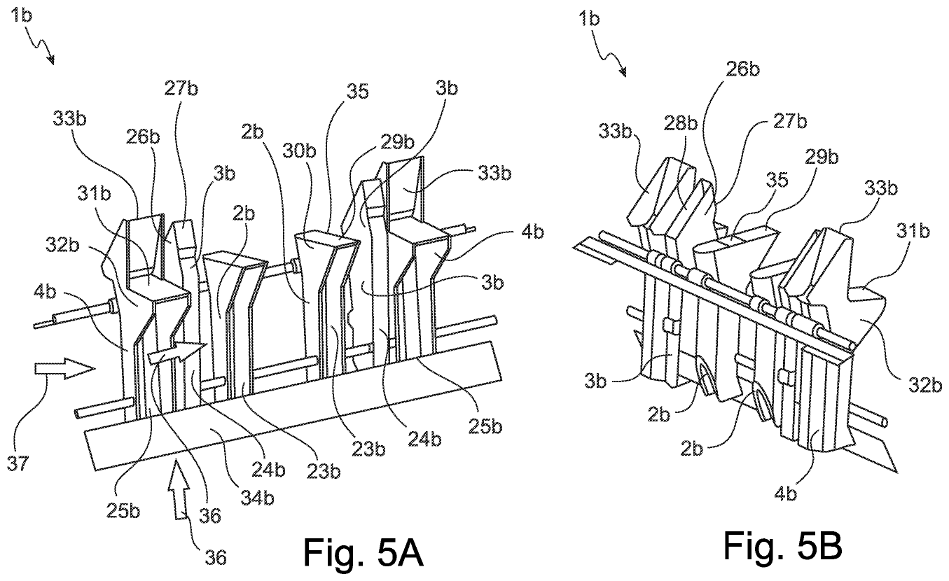

The figures FIG. 5A and FIG. 5B show an air guiding device 1b with warm air ducts 2b, 3b, 4b with an open design according to a further embodiment of the invention in a perspective representation. Here, FIG. 5A shows a perspective representation of the air guiding device 1b looking at the rear, while the perspective representation in FIG. 4B offers a view towards the front. Here, the distinction between front and rear is relative to the vehicle direction of a motor vehicle in which a motor vehicle air conditioning system provided with the air guiding device 1b is installed.

In this air guiding device 1b, too, several warm air ducts 2b, 3b, 4b are arranged substantially parallel and separated from one another and are equipped with relatively simple design features. All warm air ducts 2b, 3b, 4b have in common that they each have an at least predominantly open rear 23b, 24b, 25b and, as a result, have a U-shaped cross section with two opposite side walls as U-legs in each case and a bottom that forms a closed part on the front of the respective warm air duct 2b, 3b, 4b as a U-base.

In the arrangement of the warm air ducts 2b, 3b, 4b of this air guiding device 1b, the innermost warm air ducts 2b are oriented towards the ventilation outlets of the dashboard. These warm air ducts 2b each have an end region 30b continually enlarging up to the end face 29b, the enlargement being effected in such a way that the length of the U-legs of the U-shaped cross section of the respective warm air duct in the end region 30b increases continuously up to the end face 29b. The end faces 29b of the warm air ducts 2b towards the ventilation outlets of the dashboard are each only partially closed and provided with an air outlet opening 35 in the embodiment shown in the figures FIGS. 5A and 5B.

According to the air guiding device 1b shown in the figures FIG. 5A and FIG. 5B, the warm air ducts 3b, which are placed second or in the middle on both sides, are oriented towards the defrost outlets. These warm air ducts 3b each have an end region 26b, in which the warm air duct is closed on the rear by a wall 27b that is inclined slightly forward, whereby the open region of the rear 24b ends. Due to the inclination of the wall 27b, air that flows through the respective warm air duct 3b is directed in the direction of an outlet opening 28b of the warm air duct 3b, said outlet opening 28b being formed at the end region 26b adjacent to the wall 27b, as can be seen from the front view of the air guiding device 1b in FIG. 5B.

The warm air ducts 4b, each positioned on the outside, are provided to supply the footwell outlets with warm air and are each designed to be open on their rear 25b up to a closed end face 31b. These warm air ducts 4b also each have an end region 32b continually enlarging up to their end face 31b, the enlargement being effected in such a way that the heights of the opposite side walls and thus the lengths of the U-legs of the U-shaped cross section of the warm air duct 4b in the end region 32b increase continuously up to the end face 31b. A shielded auxiliary duct 33b originates from the end faces 31b of the warm air ducts 4b for the footwell outlets in order to guide warm air to the defrost outlet. The auxiliary ducts 33b are shielded to prevent the warm air from being blocked by cold air.

In contrast to the embodiment shown in the figures FIG. 4A and FIG. 4B, the air guiding device 1b according to figures FIG. 5A and FIG. 5B does not have individual baffles in each case in the region of the air inlet regions on the rears 23b, 24b, 25b of the warm air ducts 2b, 3b, 4b, but a common baffle 34b for all warm air ducts 2b, 3b, 4b, which runs over the entire width of the air guiding device 1b at the air inlet regions on the rears 23b, 24b, 25b of the warm air ducts 2b, 3b, 4b.

FIG. 5A shows the two main air streams that flow through the motor vehicle air conditioning system, a warm air stream 36 from the thermal heat exchanger and a cold air stream 36 from the evaporator, the thermal heat exchanger and the evaporator not being shown in FIG. 5A. Because the warm air flow 36 passing through the warm air ducts 2b, 3b, 4b is not guided through closed pipes, there is a lower pressure loss. This design causes lower local accelerations of the air passing through, which means that audible or noticeable vibrations in the vehicle can be avoided and a significant improvement in acro-acoustic performance can be achieved. This means that the characteristics in terms of audible and noticeable vibrations in the motor vehicle is improved and source of noise are reduced.

The open design also makes it possible to use relatively simple tools to manufacture the warm air ducts and the air guiding device, for example from plastic, without the need for a complex manufacturing tool with different slides. For manufacturing the air guiding device and the warm air ducts, one manufacturing tool with only one tool direction is sufficient, which means that the costs for the manufacturing tool can be significantly reduced.

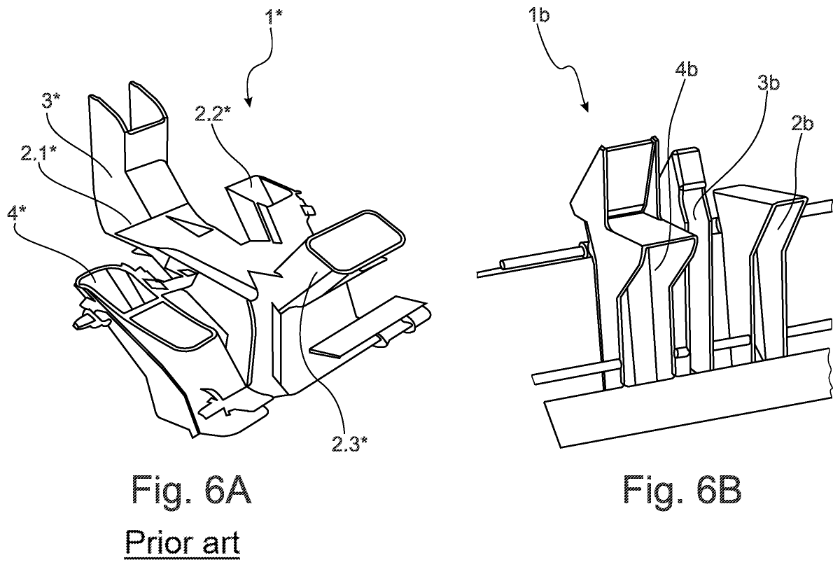

A part of an air guiding device 1* with closed warm air ducts 2.1*, 2.2*, 2.3*, 3*, 4 according to the prior art is shown in FIG. 6A in a perspective representation, and, for comparison, directly contrasted with a corresponding part of an air guiding device 1b with the open design of the warm air ducts 2b, 3b and 4b shown in perspective view in FIG. 6B. From this comparison it becomes particularly clear that, due to the construction and the open design of the warm air duct 2b, in contrast to the air guiding device 1* according to the prior art, there is no need for an additional, laterally closed warm air duct 2.3* for guiding warm air to a ventilation outlet for the back zones of the passenger compartment.

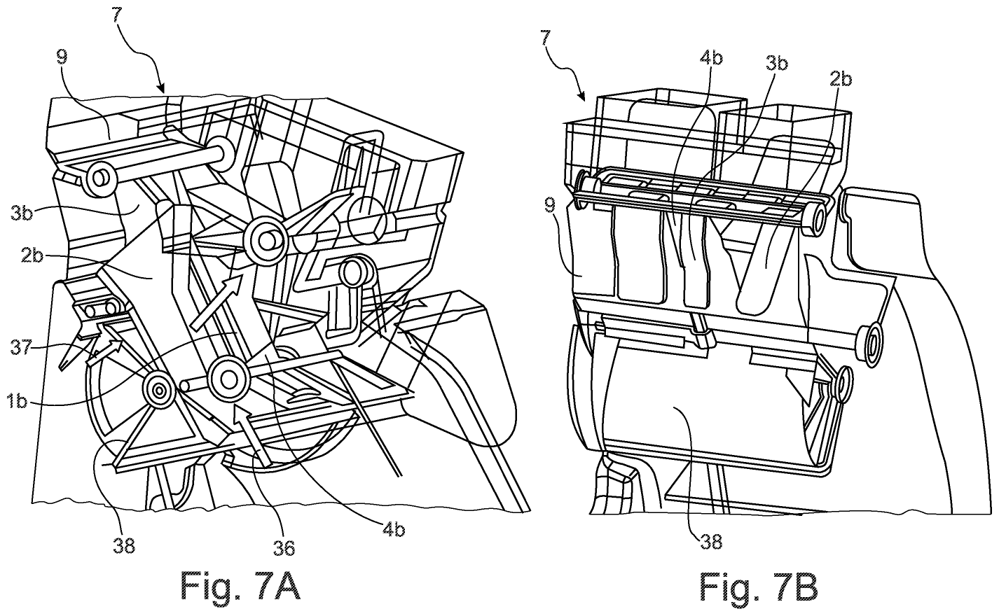

The figures FIG. 7A and FIG. 7B each show a schematic perspective representation of the arrangement of the air guiding device 1b with the warm air ducts 2b, 3b and 4b within the housing 9 of a motor vehicle air conditioning system 7, which is used to guide an air flow. The motor vehicle air conditioning system 7 has a temperature flap 38, with which the warm air path for the warm air flow 36 and/or the cold air path for the cold air flow 37 can be at least partially opened or closed.

When using an air guiding device with an open design, an improvement in airflow can be achieved, as shown by the fluid mechanical analysis (CFD-Computational Fluid Dynamics) results listed in Table 1. Due to the open design, the air volumes in the set modes are either the same or even higher when a heating mode is active. The latter applies to the footwell mode and the defrost mode. When using an air guiding device with an open design, the air volumes are about 17% higher in footwell mode and about 4% higher in defrost mode than in the corresponding modes when using an air guiding device with laterally closed air ducts. The open design, which does not force the air to flow on a specific path but only directs the air, surprisingly leads to such an increase in air volumes.

TABLE 1

| | | Ventilation | Footwell | Defrost |
|---|---|---|---|---|
| | | mode | mode | mode |
| Prior | air flow | = | − | − |
| art | speed | = | − | − |
| | torque | = | − | − |
| | current | = | − | − |
| | consumption | | | |
| Open | air flow | = | + | + |
| design | speed | = | + | + |
| | torque | = | + | + |
| | current | = | + | + |
| | consumption | | | |

### LIST OF REFERENCE NUMERALS

1* air guiding device, prior art
1a air guiding device
1b air guiding device
2.1* warm air duct for guiding warm air to a side ventilation outlet, prior art
2.2* warm air duct for guiding warm air to a central ventilation outlet, prior art
2.3* warm air duct for guiding warm air to a back ventilation outlet, prior art
2a warm air duct for guiding warm air to a ventilation outlet
2b warm air duct for guiding warm air to a ventilation outlet
3* warm air duct for guiding warm air to a defrost outlet, prior art
3a warm air duct for guiding warm air to a defrost outlet
3b warm air duct for guiding warm air to a defrost outlet
4* warm air duct for guiding warm air to a footwell outlet, prior art
4a warm air duct for guiding warm air to a footwell outlet
4b warm air duct for guiding warm air to a footwell outlet
5* base body, prior art
6* tongue and groove connection, prior art
7* motor vehicle air conditioning system, prior art
7 motor vehicle air conditioning system
8* fan, prior art
9* housing, prior art
9 housing
10* air outlet, defrost outlet, prior art
11* ventilation outlet, prior art
11.1* front zone ventilation outlet
11.2* front zone ventilation outlet
11.3* ventilation outlet for back zones
12* footwell outlet, prior art
13* evaporator, prior art
14* heat exchanger, prior art
15* cold air space, prior art
16* mixing space, prior art
17* air guiding device, prior art
18* warm air duct for guiding warm air to a ventilation outlet, prior art
19* warm air duct for guiding warm air to a defrost outlet, prior art
20* warm air duct for guiding warm air to a footwell outlet, prior art
21* bypass, prior art
22* end region, prior art
23a open rear of a warm air duct for guiding warm air to a ventilation outlet
23b open rear of a warm air duct for guiding warm air to a ventilation outlet
24a open rear of a warm air duct for guiding warm air to a defrost outlet
24b open rear of a warm air duct for guiding warm air to a defrost outlet
25a open rear of a warm air duct for guiding warm air to a footwell outlet
25b open rear of a warm air duct for guiding warm air to a footwell outlet
26a end region of a warm air duct for guiding warm air to a defrost outlet
26b end region of a warm air duct for guiding warm air to a defrost outlet
27a wall in the end region of a warm air duct for guiding warm air to a defrost outlet
27b wall in the end region of a warm air duct for guiding warm air to a defrost outlet
28a exit opening of a warm air duct for guiding warm air to a defrost outlet
28b exit opening of a warm air duct for guiding warm air to a defrost outlet
29a end face of a warm air duct for guiding warm air to a ventilation outlet
29b end face of a warm air duct for guiding warm air to a ventilation outlet
30a end region of a warm air duct for guiding warm air to a ventilation outlet
30b end region of a warm air duct for guiding warm air to a ventilation outlet
31a end face of a warm air duct for guiding warm air to a footwell outlet
31b end face of a warm air duct for guiding warm air to a footwell outlet
32a end region of a warm air duct for guiding warm air to a footwell outlet
32b end region of a warm air duct for guiding warm air to a footwell outlet
33a auxiliary duct
33b auxiliary duct
34a baffle
34b baffle
35 air outlet opening
36 warm air flow from the heat exchanger
37 cold air flow from the evaporator
38 temperature flap

What is claimed is:

1. A motor vehicle air conditioning system comprising
a fan to generate an air flow;
a housing for guiding the air flow, in which at least one defrost outlet, at least one ventilation outlet, and at least one footwell outlet are formed;
an evaporator arranged in the housing and through which the air flow can flow, and a heat exchanger arranged in the housing and through which the air flow can flow downstream of the evaporator, wherein, starting from a cold air space located downstream of the evaporator and upstream of the heat exchanger, a cold air path bypassing the heat exchanger and a warm air path running through the heat exchanger lead downstream into a mixing space, which is connected to the at least one defrost outlet, the at least one ventilation outlet, or a dashboard outlet, and the at least one footwell outlet;
an internal air guiding device with a plurality of warm air ducts at the end of the warm air path and at the entrance to the mixing space, each of the warm air ducts being designed to guide warm air in a direction of the at least one defrost outlet, the at least one ventilation outlet, or the at least one footwell outlet, wherein the warm air ducts are each designed to be open on one side along a predominant part of a course of the warm air ducts in a longitudinal direction of the warm air ducts.

2. The motor vehicle air conditioning system according to claim 1, wherein the warm air ducts are arranged separately from one another, such that several of the warm air ducts do not originate from a common connection.

3. The motor vehicle air conditioning system according to claim 1, wherein the warm air ducts are arranged parallel to one another.

4. The motor vehicle air conditioning system according to claim 1, wherein a cross section of at least one open one of the warm air ducts is U-shaped.

5. The motor vehicle air conditioning system according to claim 1, wherein at least one of the warm air ducts, which is designed to guide warm air to the at least one defrost outlet, has an end region in which the at least one of the warm air duct is closed by a wall, whereby the open region of the at least one of the warm air duct ends, the wall being adjacent to an outlet opening of the at least one of the warm air duct for guiding warm air to the at least one defrost outlet.

6. The motor vehicle air conditioning system according to claim 1, wherein at least one of the warm air ducts, which is designed to guide warm air to the at least one ventilation outlet, has an end region continually enlarging up to an end face with the end face being completely or partially closed.

7. The motor vehicle air conditioning system according to claim 6, wherein the end face is provided with an air outlet opening.

8. The motor vehicle air conditioning system according to claim 1, wherein at least one of the warm air ducts, which is designed to guide warm air to the at least one footwell outlet, has an end region continually enlarging up to an end face with the end face being completely or partially closed.

9. The motor vehicle air conditioning system according to claim 1, wherein a baffle for introducing warm air into a respective one of the warm air ducts is formed on each of the open regions of the warm air ducts.

10. The motor vehicle air conditioning system according to claim 1, wherein a common baffle is arranged for introducing warm air into the warm air ducts over an entire width of the air guiding device and the open regions of the warm air ducts.
